(19) United States
(12) Patent Application Publication
(10) Pub. No.: US 2026/0186878 A1
(43) Pub. Date: Jul. 2, 2026

(54) SYSTEM AND METHOD FOR ADAPTIVE CALIBRATION INTERVAL DETERMINATION

(71) Applicant: THE BOEING COMPANY, Arlington, VA (US)

(72) Inventors: Mahesh Purushothaman, Bengaluru (IN); William Henry Schasteen, Jr., Gilbert, WA (US); Matthew Alan McDonald, Spokane, WA (US); Deepak Kumar, Bengaluru (IN); Anket Hirachand Marathe, Bengaluru (IN); Jason Andrew Koehn, Buckley, WA (US); Prajna Gopalakrishna, Bengaluru (IN)

(21) Appl. No.: 19/006,440

(22) Filed: Dec. 31, 2024

(51) Int. Cl. G06F 11/00

(52) U.S. Cl. CPC G06F 11/008; G06F 11/004

(57) ABSTRACT

A method includes determining, based on historical data associated with a reliability group, a model fit metric for each reliability model of a plurality of reliability models. The method also includes selecting a particular reliability model based on the model fit metrics. The method also includes estimating calibration interval parameters for the reliability group based on the particular reliability model. The method also includes generating a calibration interval recommendation for the reliability group based on the calibration interval parameters and a reliability target associated with the reliability group.

### FIELD OF THE DISCLOSURE

The present disclosure generally relates to calibration management systems and, more particularly, to systems and methods for determining calibration intervals for devices using statistical reliability analysis.

### BACKGROUND

In various industries, devices must be periodically calibrated to ensure accuracy and reliability of measurements. The time between calibrations, known as the calibration interval, directly impacts both operational costs and measurement reliability. Too-frequent calibration leads to unnecessary equipment downtime and increased operational expenses, while insufficient calibration risks measurement inaccuracies that could compromise quality.

Current metrology information systems present several technical challenges in calibration interval management. These systems typically use oversimplified statistical models that do not adequately account for Type III censored data, where some devices are removed from service before failure. This limitation leads to potentially inaccurate reliability predictions, especially when dealing with small failure datasets and a large number of suspensions. Additionally, existing systems lack the capability to incorporate device age into interval calculations, despite evidence that the risk of out-of-tolerance conditions increases with age.

Traditional calibration interval determination methods include several approaches, each with significant limitations. The general interval method applies a single calibration interval across all device types, ignoring individual reliability characteristics. The borrowed interval method relies on intervals determined by external organizations, often failing to account for differences in usage patterns and environmental conditions. Engineering analysis methods, while more sophisticated, heavily depend on subjective judgment and may not consistently capture complex reliability patterns. Furthermore, current systems perform delay dating-postponing calibration beyond the originally scheduled date-without a comprehensive understanding of device reliability characteristics, potentially increasing the risk of out-of-tolerance conditions.

As measurement requirements become more stringent and device inventories more diverse, there is an increasing need for sophisticated, adaptive approaches to calibration interval determination. Such approaches must be capable of handling complex reliability patterns, incorporating multiple influencing factors, and adjusting to changing device characteristics over time.

### SUMMARY

According to one implementation of the present disclosure, a method includes determining, based on historical data associated with a reliability group, a model fit metric for each reliability model of a plurality of reliability models. The method also includes selecting a particular reliability model based on the model fit metrics. The method also includes estimating calibration interval parameters for the reliability group based on the particular reliability model. The method also includes generating a calibration interval recommendation for the reliability group based on the calibration interval parameters and a reliability target associated with the reliability group.

According to another implementation of the present disclosure, a non-transitory computer-readable medium stores instructions that, when executed by one or more processors, cause the one or more processors to determine, based on historical data associated with a reliability group, a model fit metric for each reliability model of a plurality of reliability models. The instructions further cause the one or more processors to select a particular reliability model based on the model fit metrics. The instructions further cause the one or more processors to estimate calibration interval parameters for the reliability group based on the particular reliability model. The instructions further cause the one or more processors to generate a calibration interval recommendation for the reliability group based on the calibration interval parameters and a reliability target associated with the reliability group.

According to another implementation of the present disclosure, a device includes one or more processors coupled to a memory and configured to determine, based on historical data associated with a reliability group, a model fit metric for each reliability model of a plurality of reliability models. The one or more processors are configured to select a particular reliability model based on the model fit metrics. The one or more processors are configured to estimate calibration interval parameters for the reliability group based on the particular reliability model. The one or more processors are configured to generate a calibration interval recommendation for the reliability group based on the calibration interval parameters and a reliability target associated with the reliability group.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a system for determining calibration recommendation intervals for devices.

FIG. 2 is a flow diagram illustrating operations performed by the device of FIG. 1 to determine calibration recommendation intervals for devices.

FIG. 3 is a flow chart of a method of determining calibration recommendation intervals for devices.

FIG. 4 is a diagram of electronic components of a system for determining calibration recommendation intervals for devices.

### DETAILED DESCRIPTION

Aspects disclosed herein present systems, apparatus, and methods for adaptively determining calibration intervals for devices. The system helps organizations better manage their device maintenance schedules by analyzing historical performance data and applying advanced statistical models, rather than relying on fixed intervals or simplified statistical approaches that do not account for device-specific characteristics.

The system works by analyzing different types of reliability data to determine calibration intervals. For example, the system examines historical calibration results, evaluates failure patterns, and considers device-specific factors such as age and usage. For reliability analysis, the system employs multiple statistical models including exponential, Weibull, lognormal, and mortality drift models. The system then selects the most appropriate model using statistical criteria, giving more accurate predictions than traditional single-model approaches.

To handle complex reliability patterns effectively, the system uses maximum likelihood estimation techniques for parameter calculation. First, the system processes historical calibration data to identify failure patterns and censored observations. Then, the system applies statistical models to this data to estimate reliability parameters and determine calibration intervals. This approach provides more accurate predictions than traditional methods, particularly when dealing with limited failure data or numerous censored observations.

When calculating intervals, the system accounts for multiple reliability factors. For example, it can adjust intervals based on whether a device falls into reliability corridor A (>95%), B (85-95%), or C (<85%), and further modify these based on device criticality and age. This helps ensure appropriate calibration scheduling even when devices have different reliability requirements or usage patterns.

By using the techniques and systems described herein, organizations can achieve several practical benefits. The adaptive interval determination process can handle diverse device populations while maintaining desired reliability levels. The intervals created are more appropriate because the system considers multiple statistical models and selects the best fit for each situation, unlike traditional approaches that rely on simplified assumptions. The system also reduces common calibration management problems, such as over-calibration of reliable devices or insufficient calibration of aging equipment. This approach helps organizations better maintain their devices, ultimately leading to more reliable measurements and more efficient operations.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter.

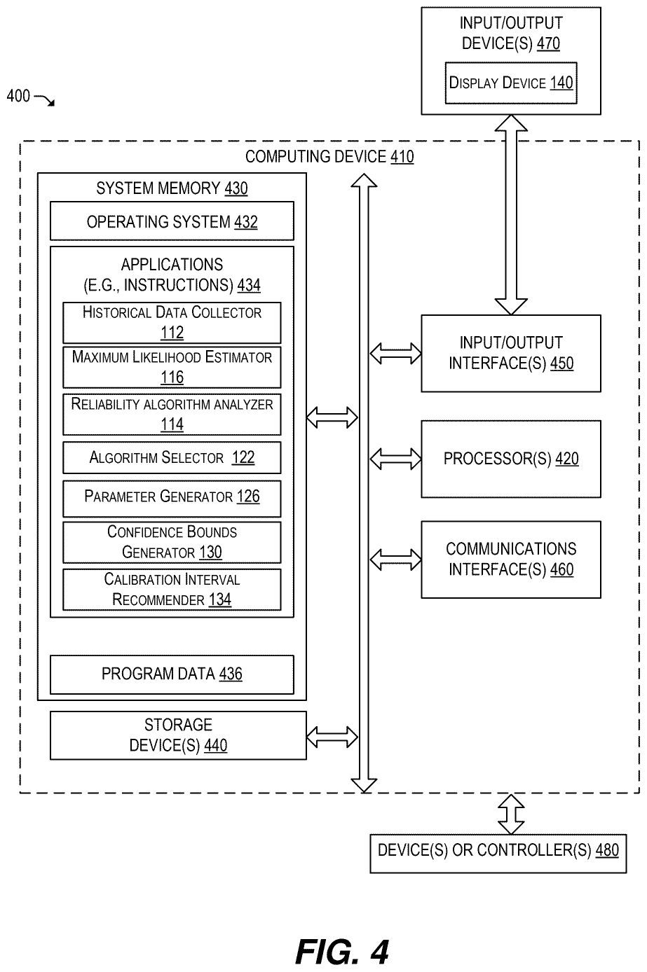

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 4 depicts a computing device 410 including one or more processors (“processor(s)” 420 in FIG. 4), which indicates that in some implementations the computing device 410 includes a single processor 420 and in other implementations the computing device 410 includes multiple processors 420. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

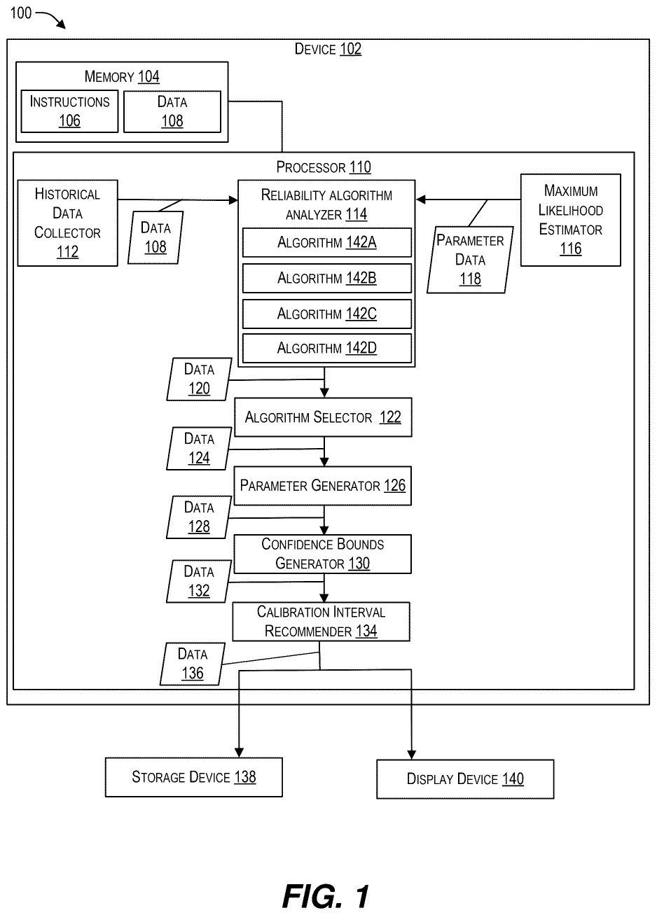

FIG. 1 illustrates a system 100 for reliability-centered calibration interval analysis. The system 100 comprises a device 102 configured to determine calibration recommendation intervals (e.g., data 136) based on data 108 (e.g., historical reliability data). The device 102 includes a memory 104 coupled to one or more processors 110. The memory 104 stores instructions 106 and the data 108.

The processor(s) 110 implements multiple components configured to execute the reliability analysis method: a historical data collector 112, a reliability algorithm analyzer 114, a maximum likelihood estimator 116, an algorithm selector 122, a parameter generator 126, a confidence bounds generator 130, a calibration interval recommender 134, or a combination thereof.

The historical data collector 112 accesses the data 108 comprising Type III censored calibration records from the memory 104. The data 108 contains multiple observations including failure events, represented in a time-series format as exemplified in Table 1:

TABLE 1

| Time (months) | Devices Calibrated | In-Tolerance Devices |
|---|---|---|
| 3 | 20 | 19 |
| 6 | 25 | 23 |
| 9 | 30 | 26 |
| 12 | 35 | 29 |

The historical data collector 112 transmits the data 108 to the reliability algorithm analyzer 114. The maximum likelihood estimator 116 generates data 118 (e.g., parameter data) for each model utilizing the likelihood function:

$${L}_{i} = {\prod }_{j = 1}^{{n}_{i}} {{R ( {t}_{i} )}^{{y}_{ij}} [ 1 - R ( {t}_{i} ) ]}^{1 - {y}_{ij}}$$

Where:
   Lᵢ represents the likelihood function for the i-th sample,
   nᵢ represents the sample size of the i-th sample,
   tᵢ represents the time corresponding to the i-th sampling interval,
   yᵢⱼ represents the j-th observation in the i-th sample, where:
      yᵢⱼ=1 for an observed in-tolerance condition,
      yᵢⱼ=0 for an observed out-of-tolerance condition, and
   R(tᵢ) represents the reliability function at time tᵢ.

For implementation of the likelihood function, consider, as an example, the analysis at t=3 months (i=1):
n₁=20 (total items calibrated)
y_{1,1} through y_{1,19}=1 (19 in-tolerance items)
y_{1,20}=0 (1 out-of-tolerance item)
t₁=3 months

Therefore:

$${L}_{1} = {{R ( 3 )}^{19} [ 1 - R ( 3 ) ]}^{1}$$

In this example, this likelihood value represents the probability of observing the specific pattern of in-tolerance and out-of-tolerance items at t=3 months, given a particular reliability function R(t). Higher likelihood values indicate better agreement between the model and observed data.

The reliability algorithm analyzer 114 is configured to implement four mathematical models through algorithms 142A-142D using the data 108 and the data 118:

Algorithm 142A implements an exponential model for constant failure rates:

$$\hat{R} ( t , \hat{θ} ) = {e}^{- {θ}_{1} * t}$$

Where:
t represents time since last calibration (in months),
θ₁ represents the failure rate parameter (failures per unit time), and
\hat{R} represents the reliability output (probability between 0 and 1).

For example, applying algorithm 142A, with θ₁=0.05:

$$t = 3 months : \hat{R} ( 3 ) = 0.86$$

$$t = 6 months : \hat{R} ( 6 ) = 0.74$$

In this example, these results indicate that at 3 months, there is an 86% probability the device will remain in tolerance (reliability corridor A), while at 6 months, this probability decreases to 74% (reliability corridor C). In this example, the device has moved from reliability corridor A through B and into C, suggesting potential calibration is needed.

Algorithm 142B implements a Weibull model for varying failure rates:

$$\hat{R} ( t , θ , β ) = {e}^{- {( \frac{t}{θ} )}^{β}}$$

Where:
t represents time since last calibration (in months),
θ represents the scale parameter (characteristic life in months),
β represents the shape parameter that determines failure rate behavior, and
\hat{R} represents the reliability output (probability between 0 and 1).

Continuing the above example, with θ=20, β=1.2:

$$t = 3 months : \hat{R} ( 3 ) = 0.9$$

$$t = 6 months : \hat{R} ( 6 ) = 0.82$$

In this example, these results indicate that at 3 months, the 90% reliability places the device in reliability corridor B and at 6 months, the 82% reliability places the device in reliability corridor C. The β>1 indicates an increasing failure rate, suggesting wear-out effects.

Algorithm 142C implements a lognormal model for wear-out scenarios:

$$\hat{R} ( ln t , ln μ , ln σ ) = 1 - ϕ [ \frac{ln t - ln μ}{ln σ} ]$$

Where:
t represents time since last calibration (in months),
μ represents the median time to failure,
σ represents the shape parameter,
φ represents the cumulative distribution function of the standard normal distribution, and
\hat{R} represents the reliability output (probability between 0 and 1).

Continuing the above example, with μ=2, σ=0.5:

$$t = 3 months : R ( 3 ) = 1 - ϕ [ \frac{ln ( 3 ) - ln ( 2 )}{ln ( 0.5 )} = 0.92$$

$$t = 6 months : R ( 6 ) = 1 - ϕ [ \frac{ln ( 6 ) - ln ( 2 )}{ln ( 0.5 )} = 0.84$$

In this example, these results indicate that at 3 months, the 92% reliability places the device in reliability corridor B (85-95%) and at 6 months, the 84% reliability places the device in reliability corridor C (<85%). The transition from 92% to 84% reliability over a 3-month period indicates a wear-out pattern typical of devices subject to aging effects.

Algorithm 142D implements a mortality drift model:

$$\hat{R} ( t , θ , β ) = {e}^{- ( λ t + β {t}^{2} )}$$

Where:
t represents time since last calibration (in months),
λ represents the initial failure rate,
β represents the drift parameter, which should be much smaller than λ), and
\hat{R} represents the reliability output (probability between 0 and 1).

Continuing the above example, with λ=0.04, β=0.001:

$$t = 3 months : R ( 3 ) = {e}^{- ( 0.04 * 3 + 0.001 * 3 {t}^{2} )} = 0.89$$

$$t = 6 months : R ( 6 ) = {e}^{- ( 0.04 * 6 + 0.001 * {6}^{2} )} = 0.77$$

In this example, these results indicate that at 3 months, the 89% reliability places the device in reliability corridor B and at 6 months, the 77% reliability places the device in reliability corridor C. The small positive β indicates a gradually increasing failure rate.

The algorithm selector 122 is configured to select the best-fit model using the Corrected Akaike Information Criterion (AICc):

$$AICc = AIC + \frac{2 k ( k + 1 )}{n - k - 1}$$

Where:
AIC is the Akaike Information Criterion, calculated as: AIC=−2 ln(L)+2k,
L represents the maximum likelihood value from the model,
k represents the number of estimated parameters in the model, and
n represents the sample size.

The AICc provides several advantages over the standard AIC for calibration interval analysis. First, it includes a correction factor that accounts for finite sample sizes, which is particularly important in reliability groups with limited calibration history. This correction factor increases the penalty for model complexity as the sample size decreases relative to the number of parameters, helping prevent overfitting in smaller reliability groups.

The algorithm selector 122 is configured to calculate the AICc value for each of the algorithms 142 (Exponential, Weibull, Lognormal, and Mortality Drift & Random Walk Model) fitted to the data 108. The algorithm 142 with the lowest AICc value is selected as the best fit for that particular reliability group, as it represents an acceptable balance between model fit and complexity given the available data. This approach ensures that the selected model is appropriate for the specific characteristics and sample size of each reliability group, leading to more accurate calibration interval predictions.

Continuing the above example, with n=110 total calibration measurements:

Exponential model (k=1):

$$AIC = - 2 ln ( 1.23 ( {10}^{- 12} ) ) + 2 ( 1 ) = 56.26 ,$$

$$AICc = 56.26 + \frac{2 ( 1 ) ( 1 + 1 )}{110 - 1 - 1} = 56.3$$

Weibull model (k=2):

$$AIC = - 2 ln ( 3.45 ( {10}^{- 10} ) ) + 2 ( 2 ) = 47.82 ,$$

$$AICc = 47.82 + \frac{2 ( 2 ) ( 2 + 1 )}{110 - 2 - 1} = 48.04$$

Lognormal model (k=2):

$$AIC = - 2 ln ( 2.85 ( {10}^{- 10} ) ) + 2 ( 2 ) = 48.6 ,$$

$$AICc = 48.6 + \frac{2 ( 2 ) ( 2 + 1 )}{110 - 2 - 1} = 48.82$$

Mortality drift model (k=2):

$$AIC = - 2 ln ( 2.1291 {0}^{- 11 )} ) + 2 ( 2 ) = 52.38 ,$$

$$AICc = 52.38 + \frac{2 ( 2 ) ( 2 + 1 )}{110 - 2 - 1} = 52.60$$

In this example, these AICc values reveal several key characteristics about the models' fit to the data 108. The Weibull model achieves the lowest AICc value of 48.04, indicating it provides the best statistical fit to the data 108. The lognormal model follows with an AICc of 48.82, suggesting it also captures the reliability behavior well. The small difference between these two models (ΔAICc=0.78) indicates that both provide similarly good fits to the data 108, with the Weibull model having a slight edge in balancing fit quality with model complexity.

Continuing this example, the mortality drift model shows a notably higher AICc value of 52.60, while the exponential model has the highest AICc at 56.30. The substantial gap between these models and the Weibull/lognormal models (ΔAICc>4) provides strong evidence against both the constant-failure-rate assumption of the exponential model and the drift characteristics of the mortality drift model for this particular device.

In this example, this comparative analysis identifies the Weibull model as the most appropriate choice for predicting future reliability behavior, closely followed by the lognormal model. The selection of the Weibull model suggests that the device's failure probability follows a pattern with an increasing failure rate (β>1), which has important implications for setting calibration intervals and performing delay dating calculations. The near-equivalent performance of the lognormal model provides additional confidence in this characterization, as both models are well-suited to capturing wear-out behavior. Based on the AICc analysis, the algorithm selector 122 is configured to generate data 124. The data 124 includes the selected best-fit model, which in this example is the Weibull model, along with model parameters (θ=20, β=1.2), the parameter covariance matrix, a log-likelihood value of −3.45×10\hat{ }−10, convergence metrics, and AICc values for all models (Weibull: 48.04, lognormal: 48.82, mortality drift: 52.60, exponential: 56.30).

The parameter generator 126 is configured to process the data 124 to generate data 128. The parameter generator 126 implements parameter bound calculations using the following equations:

$$Upper bound on β : {β}_{u} = \hat{β} * {e}^{\frac{{κ}_{α} * \sqrt{var \hat{β}}}{\hat{β}}}$$

$$Lower bound on β : {β}_{l} = \frac{\hat{β}}{{e}^{\frac{{κ}_{α} * \sqrt{var \hat{β}}}{\hat{β}}}}$$

$$Upper bound on θ : {θ}_{u} = \hat{θ} * {e}^{\frac{{κ}_{α} * \sqrt{var \hat{θ}}}{\hat{θ}}}$$

$$Lower bound on θ : {θ}_{l} = \frac{\hat{θ}}{{e}^{\frac{{κ}_{α} * \sqrt{var \hat{θ}}}{\hat{θ}}}}$$

Where:
\hat{β} represents the estimated shape parameter,
\hat{θ} represents the estimated scale parameter,
Kₐ represents the confidence level factor from the standard normal distribution,
var\hat{β} represents the variance of the shape parameter estimate, and
var\hat{θ} represents the variance of the scale parameter estimate.

For example, using the selected Weibull model parameters (\hat{β}=1.2, \hat{θ}=20) and a 90% confidence level (Kₐ=1.645), with calculated variances var\hat{β}=0.0144 and var\hat{θ}=4.0, the parameter bounds are: upper bound on β=1.32, lower bound on β=1.09, upper bound on θ=23.1, and lower bound on θ=17.3. In this example, these results indicate the true shape parameter β lies between 1.09 and 1.32, and the scale parameter θ lies between 17.3 and 23.1 with 90% confidence.

The confidence bounds generator 130 is configured to calculate Type-I (time) bounds by first solving the reliability equation with respect to time. The process begins with the base reliability equation:

$$l n R = {( - \frac{t}{θ} )}^{β}$$

This equation can then be transformed to:

$$ln ( - ln ( R ) ) = β ( ln t - ln θ )$$

Which leads to the time transformation equation:

$$u = \frac{1}{β} * ln ( - ln ( R ) ) + ln θ , where u = ln t$$

The bounds on u are then calculated:

$$u = \frac{1}{β} * ln ( - ln ( R ) ) + ln θ$$

$${u}_{l} = \hat{u} - {K}_{α} \sqrt{Var ( û )}$$

Where:
u represents the transformed time variable,
û represents the estimate of u, and
Kₐ represents the confidence level factor.

Var(û) represents the variance of u calculated as:

$$Var ( u ) = {( \frac{\partial u}{\partial β} )}^{2} * Var ( \hat{β} ) + 2 * \frac{\partial u}{\partial β} * \frac{\partial u}{\partial θ} * cov ( \hat{β} , \hat{θ} ) + {( \frac{\partial u}{\partial θ} )}^{2} * var ( \hat{θ} )$$

The final time bounds are then calculated as:

$${t}_{u} = {e}^{{u}_{u}}$$

$${t}_{l} = {e}^{{u}_{l}}$$

Continuing our example, at t=6 months: u=−1.90, Var(û)=0.0324, uᵤ=−1.60, uₗ=−2.20, tᵤ=7.1 months, and tₗ=5.1 months. In this example, these calculations indicate with 90% confidence that the true time to reach the specified reliability level lies between 5.1 and 7.1 months.

The confidence bounds generator 130 is configured to calculate Type-II (reliability) bounds starting with the transformed Weibull reliability equation:

$$R ( t ) = {e}^{- {e}^{β ( lnt - ln θ )}}$$

The calculation process begins by defining the transformation:

$$Let u = β ( l n t - ln θ )$$

Which allows the reliability function to be expressed in terms of u:

$$R ( t ) = {e}^{- {e}^{u}}$$

The bounds on u are calculated as:

$${u}_{u} = û + {K}_{α} \sqrt{Var ( û )}$$

$${u}_{l} = û - {K}_{α} \sqrt{Var ( û )}$$

Where:
u represents the transformed reliability variable,
û represents the estimate of u, and
Kₐ represents the confidence level factor.

Var(û) represents the variance of u calculated as:

$$Var ( u ) = {( \frac{\partial u}{\partial β} )}^{2} * Var ( \hat{β} ) + 2 * \frac{\partial u}{\partial β} * \frac{\partial u}{\partial θ} * cov ( \hat{β} , \hat{θ} ) + {( \frac{\partial u}{\partial θ} )}^{2} * var ( \hat{θ} )$$

The final reliability bounds are then calculated as:

$${R}_{u} = {e}^{- {e}^{{u}_{l}}}$$

$${R}_{l} = {e}^{- {e}^{{u}_{u}}}$$

Continuing the above example, at t=6 months: u=−1.90, Var(û)=0.0324 uᵤ=−1.60, uₗ=−2.20, Rᵤ=0.85, and Rₗ=0.79. In this example, these calculations demonstrate that with 90% confidence, the true reliability at 6 months lies between 79% and 85%, indicating the device is approaching the lower threshold of Corridor C.

The confidence bounds generator 130 is configured to generate data 132 that includes the statistical analysis results for the reliability calculations. The data 132 includes the calculated reliability values and bounds at t=6 months (R=0.82, Rᵤ=0.85, Rₗ=0.79), the parameter estimates and their confidence bounds (β=1.2 [1.09, 1.32], θ=20 [17.3, 23.1]), the specified 90% confidence level information, time-based confidence intervals, the associated statistical validity metrics for the bounds, or a combination thereof. The confidence bounds generator 130 transmits the data 132 to the calibration interval recommender 134 for further processing.

The calibration interval recommender 134 is configured to process the data 132 to perform delay dating using conditional reliability calculations. The conditional reliability is calculated using:

$$R ( t \vert T ) = \frac{R ( t + T )}{R ( t )}$$

Where:
t represents additional operation time (mission time),
T represents current age of device,
R(t|T) represents conditional reliability,
R(t+T) represents reliability at total time, and
R(T) represents reliability at current age.

Continuing the above example, using the reliability values from the data 132 with T=24 months and t=6 months: R(T)=0.92. With the parameter bounds from the data 132 (β: [1.09, 1.32], θ: [17.3, 23.1]), the conditional reliability bounds are: Rᵤ=0.95 and Rₗ=0.89. Based on these calculations, the calibration interval recommender 134 generates data 136 comprising the recommended calibration interval of 6 months, supported by the 92% conditional reliability with confidence bounds of [89%, 95%]. The data 136 can include the reliability analysis, corridor assignment (Corridor B), delay dating recommendations, implementation guidance for different criticality scenarios, or a combination thereof.

In some aspects, the calibration interval recommender 134 is configured to implement a hierarchical selection process to determine the recommended interval based on reliability values. First, the calibration interval recommender 134 generates a set of candidate intervals corresponding to reliability values ranging from 75% to 99% in 1% increments. For each candidate interval, the calibration interval recommender 134 calculates both the point estimate and confidence bounds on the reliability using the selected model's parameters. The calibration interval recommender 134 then filters these candidates based on the reliability target associated with the reliability group—for example, selecting only intervals achieving at least 95% reliability for critical equipment (reliability corridor A), or between 85% and 95% for standard equipment (reliability corridor B). From the filtered candidates, the calibration interval recommender 134 selects the interval that minimizes the difference between its achieved reliability and the target reliability while maintaining the required confidence level. This selection process ensures that the recommended interval matches the reliability requirements while accounting for statistical uncertainty.

The calibration interval recommender 134 transmits the data 136 to both the storage device 138 and the display device 140. The storage device 138 maintains a permanent record of the data 136, including the reliability analysis, parameter estimates, confidence bounds, and recommendations. This stored data 136 can serve as a historical record for trend analysis, audit purposes, and future calibration interval optimization.

The display device 140 is configured to present the data 136 to users through an interactive interface showing the recommended calibration interval (6 months), reliability metrics (92% conditional reliability), confidence bounds [89%, 95%], and corridor assignment (Corridor B). The display device 140 includes user interface elements allowing users to review the supporting analysis and either confirm the recommended interval, request modifications based on operational requirements, or reject the recommendation. Upon user input, the display device 140 updates the data 136 in the storage device 138 with the user's decision and any associated comments, maintaining a complete record of the calibration interval determination process.

By using the techniques and systems described herein, the device 102 has the technical advantages of providing enhanced calibration interval predictions through a multi-model reliability analysis framework. The device's 102 implementation of four algorithms 142 (Exponential, Weibull, Lognormal, and Mortality Drift) with maximum likelihood estimation enables more accurate calibration interval predictions compared to conventional single-model approaches. This multi-model architecture, combined with Type III censored data processing capabilities, reduces prediction errors by capturing complex failure patterns that simpler exponential-only systems cannot detect.

The device 102 also provides technical advantages through its innovative model selection mechanism using the Corrected Akaike Information Criterion (AICc). Unlike traditional systems that rely on basic goodness-of-fit metrics, the AICc implementation automatically accounts for sample size and model complexity, preventing overfitting in smaller reliability groups. This adaptive model selection approach ensures a balance between fit accuracy and model parsimony, particularly beneficial when analyzing devices with limited calibration history.

The device 102 further provides enhanced statistical reliability through its dual-bound confidence calculation architecture. By implementing both Type-I (time-based) and Type-II (reliability-based) confidence bounds calculations, the device 102 generates comprehensive uncertainty quantification that conventional single-bound approaches cannot achieve.

The device 102 also provides technical advantages through its conditional reliability processing engine for delay dating calculations. Unlike traditional fixed-interval systems, this approach dynamically adjusts calibration recommendations based on device age and operational history. The device's 102 ability to calculate reliability bounds using transformed variables and parameter covariance matrices enables more precise delay dating decisions, reducing unnecessary calibrations while maintaining reliability targets within specified confidence intervals.

The device 102 additionally provides technical advantages through its integrated parameter bound calculation mechanism. By implementing simultaneous upper and lower bound calculations for both shape and scale parameters, the device 102 enables more precise reliability corridor assignments compared to conventional point-estimate approaches. This comprehensive parameter analysis, combined with the device's 102 real-time confidence bound updates, ensures calibration intervals remain viable even as devices age, and their reliability characteristics evolve.

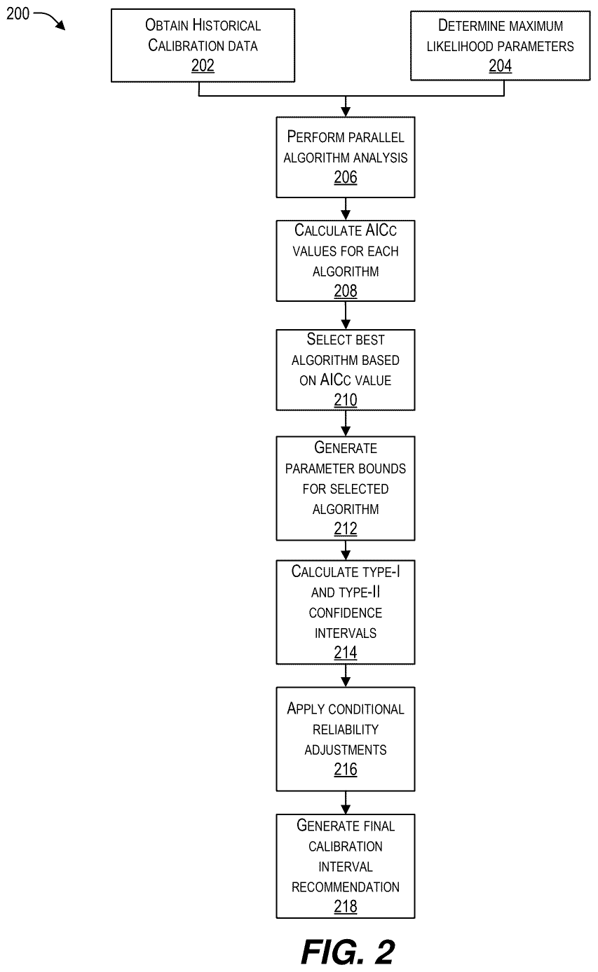

FIG. 2 is a flow diagram 200 illustrating operations performed by the device 102 to determine calibration intervals for devices from the data 108. The device 102 is configured to execute the operations through the various components described in FIG. 1, including the historical data collector 112, the reliability algorithm analyzer 114, the maximum likelihood estimator 116, the algorithm selector 122, the parameter generator 126, the confidence bounds generator 130, and the calibration interval recommender 134.

At block 202, the historical data collector 112 obtains the historical data (e.g., data 108) from the memory 104 of the device 102 or from a storage device separate from the device 102. The historical data includes Type III censored calibration records containing multiple observations including failure events. For example, consider a torque wrench with the following calibration history over a 12-month period: at 3 months, 20 devices were calibrated with 19 in-tolerance; at 6 months, 25 devices were calibrated with 23 in-tolerance; at 9 months, 30 devices were calibrated with 26 in-tolerance; and at 12 months, 35 devices were calibrated with 29 in-tolerance.

At block 204, the maximum likelihood estimator 116 determines maximum likelihood parameters for each reliability model using the historical data. Continuing with the torque wrench example, the maximum likelihood estimator 116 processes the observed in-tolerance and out-of-tolerance counts to generate initial parameter estimates, as described above in FIG. 1. For the Weibull model (algorithm 142B), this results in initial estimates of shape parameter β=1.2 and scale parameter θ=20 months.

At block 206, the reliability algorithm analyzer 114 performs parallel algorithm analysis using the four algorithms: exponential model (algorithm 142A), Weibull model (algorithm 142B), lognormal model (algorithm 142C), and mortality drift model (algorithm 142D). For the torque wrench data, each algorithm 142A-D calculates reliability values. For instance, at 6 months, the Weibull model predicts 82% reliability, the exponential model predicts 74% reliability, the lognormal model predicts 84% reliability, and the mortality drift model predicts 77% reliability.

At block 208, the algorithm selector 122 calculates the Corrected Akaike Information Criterion (AICc) values for each algorithm 142A-D. The AICc calculation evaluates both how well the model fits the observed data and its complexity, with a correction factor that accounts for finite sample sizes. For the torque wrench example, the calculated AICc values are: Weibull model (48.04), lognormal model (48.82), mortality drift model (52.60), and exponential model (56.30).

At block 210, the algorithm selector 122 selects the best-fit model based on the calculated AICc values. For the torque wrench, the Weibull model (e.g., algorithm 142B) is selected as it has the lowest AICc value (48.04), indicating it provides the best balance between model fit and complexity for this reliability group.

At block 212, the parameter generator 126 generates parameter bounds for the selected algorithm. For the torque wrench's Weibull model, (e.g., algorithm 142B) using a 90% confidence level, the parameter bounds are calculated as: shape parameter β=1.2 with bounds [1.09, 1.32] and scale parameter θ=20 months with bounds [17.3, 23.1].

At block 214, the confidence bounds generator 130 calculates Type-I and Type-II confidence intervals. For the torque wrench at 6 months, the Type-I bounds indicate the true time to reach 82% reliability lies between 5.1 and 7.1 months. The Type-II bounds show the true reliability at 6 months lies between 79% and 85%.

At block 216, the calibration interval recommender 134 applies conditional reliability adjustments. For the torque wrench example, assuming the device is 24 months old and considering a future 6-month mission time, the conditional reliability calculation yields 92% with confidence bounds of [89%, 95%].

At block 218, the calibration interval recommender 134 generates the final calibration interval recommendation based on the reliability target associated with the reliability group. For the torque wrench, based on the calculated 82% reliability at 6 months (reliability corridor C) and the device's criticality level, the system recommends a 6-month calibration interval to maintain the device within reliability corridor B (85-95%).

Throughout the process, the device 102 maintains the ability to adjust calibration intervals based on criticality, usage, and age of the device in the reliability group. For the torque wrench example, if it is designated as a critical device, the recommended interval would be further adjusted to achieve reliability corridor A (>95%).

The final calibration interval recommendation is stored in the storage device 138 and displayed on the display device 140, showing the 6-month interval recommendation along with the supporting reliability analysis, corridor assignment (reliability corridor B), and confidence bounds. Users can then review these results and adjust based on specific operational requirements.

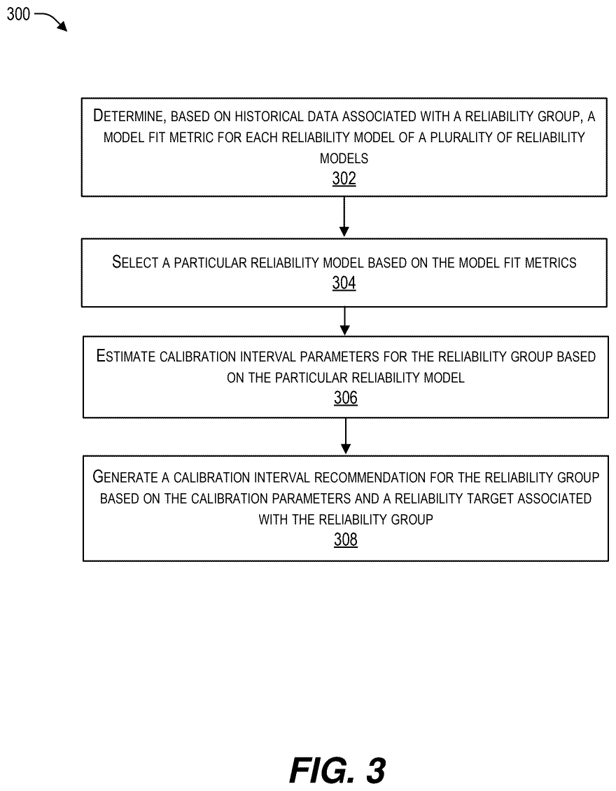

FIG. 3 illustrates a method 300 of determining a calibration interval recommendation. The method 300 includes, at block 302, determining, based on historical data associated with a reliability group, a model fit metric for each reliability model of a plurality of reliability models. For example, the historical data collector 112 accesses Type III censored calibration data (e.g., data 108) for a reliability group of torque wrenches collected over a 12-month period, where at 3 months, 20 devices were calibrated with 19 in-tolerance; at 6 months, 25 devices were calibrated with 23 in-tolerance; at 9 months, 30 devices were calibrated with 26 in-tolerance; and at 12 months, 35 devices were calibrated with 29 in-tolerance. The reliability algorithm analyzer 114 processes this data through algorithms 142A-D while the algorithm selector 122 calculates the Corrected Akaike Information Criterion (AICc) value for each model. With n=110 total calibration measurements, the algorithm selector 122 determines: exponential model (algorithm 142A, k=1): AICc=56.30; Weibull model (algorithm 142B, k=2): AICc=48.04; lognormal model (algorithm 142C, k=2): AICc=48.82; and mortality drift model (algorithm 142D, k=2): AICc=52.60.

The method 300 includes, at block 304, selecting a particular reliability model based on the model fit metrics. For example, the algorithm selector 122 evaluates the AICc values and selects the Weibull model (algorithm 142B) for the torque wrench reliability group as it demonstrates the lowest AICc value (48.04).

The method 300 includes, at block 306, estimating calibration interval parameters for the reliability group based on the particular reliability model. For example, the maximum likelihood estimator 116 processes the selected Weibull model to determine the shape parameter β=1.2 and scale parameter θ=20 months. The parameter generator 126 then uses a 90% confidence level (Kₐ=1.645) and calculated variances (varβ′=0.0144, varθ′=4.0) to establish parameter bounds: shape parameter β between 1.09 and 1.32, and scale parameter θ between 17.3 and 23.1 months. The confidence bounds generator 130 calculates Type-I time bounds at t=6 months, yielding bounds between 5.1 and 7.1 months, and Type-II reliability bounds showing the true reliability at 6 months lies between 79% and 85%.

The method 300 includes, at block 308, generating a calibration interval recommendation for the reliability group based on the calibration parameters and a reliability target associated with the reliability group. For example, the calibration interval recommender 134 processes the data 132 for the torque wrench reliability group. Given the calculated reliability of 82% at 6 months (placing it in reliability corridor C) and considering a device age of 24 months, the calibration interval recommender 134 applies conditional reliability calculations. This yields a conditional reliability of 92% with confidence bounds [89%, 95%] for a 6-month mission time. Based on these results and the reliability corridor requirements (A: >95%, B: 85-95%, C: <85%), the calibration interval recommender 134 generates data 136 recommending a 6-month calibration interval. For critical devices requiring reliability corridor A (>95%), the calibration interval recommender 134 adjusts this interval downward to maintain the higher reliability target. The calibration interval recommender 134 transmits the data 136 to both the storage device 138 for permanent record keeping and the display device 140 for user review and confirmation, with the data 136 including comprehensive implementation guidance accounting for device criticality, usage patterns, and age-related factors.

FIG. 4 is a block diagram of a computing environment 400 including a computing device 410 configured to support aspects of computer-implemented methods and computer-executable program instructions (or code) according to the present disclosure. For example, the computing device 410, or portions thereof, is configured to execute instructions to initiate, perform, or control one or more operations described with reference to FIGS. 1-3.

The computing device 410 includes one or more processors 420. In some aspects, the processor(s) 420 includes the processor(s) 110, as described in FIG. 1. The processor(s) 420 are configured to communicate with system memory 430, one or more storage devices 440, one or more input/output interfaces 450, one or more communications interfaces 460, or any combination thereof. The system memory 430 includes volatile memory devices (e.g., random access memory (RAM) devices), nonvolatile memory devices (e.g., read-only memory (ROM) devices, programmable read-only memory, and flash memory), or both. The system memory 430 stores an operating system 432, which may include a basic input/output system for booting the computing device 410 as well as a full operating system to enable the computing device 410 to interact with users, other programs, and other devices. The system memory 430 stores system (program) data 436, such as the historical data collector 112, the reliability algorithm analyzer 114, the maximum likelihood estimator 116, the algorithm selector 122, the parameter generator 126, the confidence bounds generator 130, and the calibration interval recommender 134, or a combination thereof.

The system memory 430 includes one or more operating systems 432 and/or one or more applications 434 (e.g., sets of instructions) executable by the processor(s) 420. As an example, the one or more applications 434 include instructions executable by the processor(s) 420 to initiate, control, or perform one or more operations described with reference to FIGS. 1-3, such as determining, based on historical data associated with a reliability group, a model fit metric for each reliability model of a plurality of reliability models; selecting a particular reliability model based on the model fit metrics; estimating calibration interval parameters for the reliability group based on the particular reliability model; and generating a calibration interval recommendation for the reliability group based on the calibration parameters and a reliability target associated with the reliability group.

In a particular implementation, the system memory 430 includes a non-transitory, computer-readable medium storing the instructions that, when executed by the processor(s) 420, cause the processor(s) 420 to initiate, perform, or control operations to aid in determining calibration interval recommendation. The operations include determining, based on historical data associated with a reliability group, a model fit metric for each reliability model of a plurality of reliability models; selecting a particular reliability model based on the model fit metrics; estimating calibration interval parameters for the reliability group based on the particular reliability model; and generating a calibration interval recommendation for the reliability group based on the calibration parameters and a reliability target associated with the reliability group.

The one or more storage devices 440 include nonvolatile storage devices, such as magnetic disks, optical disks, or flash memory devices. In a particular example, the storage devices 440 include both removable and non-removable memory devices. The storage devices 440 are configured to store an operating system, images of operating systems, applications (e.g., one or more of the applications 434), and program data (e.g., the program data 436). In a particular aspect, the system memory 430, the storage devices 440, or both, include tangible computer-readable media. In a particular aspect, one or more of the storage devices 440 are external to the computing device 410.

The one or more input/output interfaces 450 enable the computing device 410 to communicate with one or more input/output devices 470 to facilitate user interaction. For example, the one or more input/output interfaces 450, an input interface, or both. For example, the input/output interface 450 is adapted to receive input from a user, to receive input from another computing device, or a combination thereof. In some implementations, the input/output interface 450 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 470 includes one or more user interface devices and displays, including some combination of buttons, keyboards, pointing devices, displays, speakers, microphones, touch screens, and other devices.

The processor(s) 420 are configured to communicate with devices or controllers 480 via the one or more communications interfaces 460. For example, the one or more communications interfaces 460 can include a network interface.

In some implementations, a non-transitory, computer-readable medium stores instructions that, when executed by one or more processors, cause the one or more processors to initiate, perform, or control operations to perform part or all of the functionality described above. For example, the instructions may be executable to implement one or more of the operations or methods of FIGS. 1-3. In some implementations, part, or all of one or more of the operations or methods of FIGS. 1-3 may be implemented by one or more processors (e.g., one or more central processing units (CPUs), one or more graphics processing units (GPUs), one or more digital signal processors (DSPs)) executing instructions, by dedicated hardware circuitry, or any combination thereof.

Particular aspects of the disclosure are described below in sets of interrelated Examples:
According to Example 1, a method includes determining, based on historical data associated with a reliability group, a model fit metric for each reliability model of a plurality of reliability models; selecting a particular reliability model based on the model fit metrics; estimating calibration interval parameters for the reliability group based on the particular reliability model; and generating a calibration interval recommendation for the reliability group based on the calibration interval parameters and a reliability target associated with the reliability group.
Example 2 includes the method of Example 1, further comprising generating initial parameter estimates for each reliability model of the plurality of reliability models.
Example 3 includes the method of Example 1 or Example 2, wherein the model fit metric is a Corrected Akaike Information Criterion (AICc) value.
Example 4 includes the method of any of Examples 1 to 3, wherein estimating the calibration interval parameters comprises performing a maximum likelihood estimation.
Example 5 includes the method of any of Examples 1 to 4 and further includes determining confidence bounds on the calibration interval parameters.
Example 6 includes the method of Example 5, wherein determining the confidence bounds comprises: determining a variance and covariance of the calibration interval parameters from an inverse Hessian matrix of a log-likelihood function; and applying the variance and covariance to establish upper and lower bounds on the calibration interval parameters at a specified confidence level.
Example 7 includes the method of any of Examples 1 to 6, wherein the calibration interval parameters include recommended intervals for each of a plurality of reliability values.
Example 8 includes the method of Example 7, wherein generating the calibration interval recommendation comprises selecting a recommended interval from the recommended intervals, wherein the recommended interval is associated with a reliability value satisfying the reliability target.
Example 9 includes the method of any of Examples 1 to 8, wherein the plurality of reliability models comprise at least one of an exponential model, a Weibull model, a lognormal model, and a mortality drift model.
Example 10 includes the method of any of Examples 1 to 9 and further includes adjusting the calibration interval recommendation based on at least one of criticality, usage, and age of a Measurement & Test Equipment (M&TE) in the reliability group.
Example 11 includes the method of any of Examples 1 to 10 and further includes performing delay dating of a M&TE in the reliability group based on conditional reliability.
According to Example 12, a non-transitory computer-readable medium stores instructions that, when executed by one or more processors, cause the one or more processors to determine, based on historical data associated with a reliability group, a model fit metric for each reliability model of a plurality of reliability models; select a particular reliability model based on the model fit metrics; estimate calibration interval parameters for the reliability group based on the particular reliability model; and generate a calibration interval recommendation for the reliability group based on the calibration interval parameters and a reliability target associated with the reliability group.
Example 13 includes the non-transitory computer-readable medium of Example 12, wherein the one or more processors are configured to generate initial parameter estimates for each reliability model of the plurality of reliability models.
Example 14 includes the non-transitory computer-readable medium of Example 12 or Example 13, wherein the model fit metric is a Corrected Akaike Information Criterion (AICc) value.
Example 15 includes the non-transitory computer-readable medium of any of Examples 12 to 14, wherein estimating the calibration interval parameters comprises performing a maximum likelihood estimation.
Example 16 includes the non-transitory computer-readable medium of any of Examples 12 to 15, wherein the one or more processors are configured to determine confidence bounds on the calibration interval parameters.
Example 17 includes the non-transitory computer-readable medium of Example 16, wherein the one or more processors are configured to determine a variance and covariance of the calibration interval parameters from an inverse Hessian matrix of a log-likelihood function; and apply the variance and covariance to establish upper and lower bounds on the calibration interval parameters at a specified confidence level.
Example 18 includes the non-transitory computer-readable medium of any of Examples 14 to 17, wherein the calibration interval parameters include recommended intervals for each of a plurality of reliability values.
Example 19 includes the non-transitory computer-readable medium of any of Examples 12 to 18, wherein the plurality of reliability models comprise at least one of an exponential model, a Weibull model, a lognormal model, and a mortality drift model.
According to Example 20, a device includes one or more processors coupled to a memory configured to determine, based on historical data associated with a reliability group, a model fit metric for each reliability model of a plurality of reliability models; select a particular reliability model based on the model fit metrics; estimate calibration interval parameters for the reliability group based on the particular reliability model; and generate a calibration interval recommendation for the reliability group based on the calibration interval parameters and a reliability target associated with the reliability group.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

1. A method comprising:
determining, at a processor and based on historical data associated with a reliability group, a model fit metric for each reliability model of a plurality of reliability models;
selecting, at the processor, a particular reliability model based on the model fit metrics;
estimating, at the processor, calibration interval parameters for the reliability group based on the particular reliability model; and
generating, at the processor, a calibration interval recommendation for the reliability group based on the calibration interval parameters and a reliability target associated with the reliability group, wherein generating the calibration interval recommendation comprises selecting a recommended interval from a set of candidate intervals, wherein the recommended interval achieves a reliability value satisfying the reliability target.

2. The method of claim 1, further comprising generating, at the processor, initial parameter estimates for each reliability model of the plurality of reliability models.

3. The method of claim 1, wherein the model fit metric is a Corrected Akaike Information Criterion (AICc) value.

4. The method of claim 1, wherein estimating the calibration interval parameters comprises performing a maximum likelihood estimation.

5. The method of claim 1, further comprising determining, at the processor, confidence bounds on the calibration interval parameters.

6. The method of claim 5, wherein determining the confidence bounds comprises:
determining, at the processor, a variance and covariance of the calibration interval parameters from an inverse Hessian matrix of a log-likelihood function; and
applying, at the processor, the variance and covariance to establish upper and lower bounds on the calibration interval parameters at a specified confidence level.

7. The method of claim 1, wherein the calibration interval parameters include recommended intervals for each of a plurality of reliability values.

8. The method of claim 1, wherein generating the calibration interval recommendation comprises filtering the candidate intervals based on a confidence level associated with the reliability value, and selecting a recommended interval from the filtered candidate intervals, wherein the recommended interval is associated with the reliability value satisfying the reliability target.

9. The method of claim 1, wherein the plurality of reliability models comprise at least one of an exponential model, a Weibull model, a lognormal model, and a mortality drift model.

10. The method of claim 1, further comprising adjusting, at the processor, the calibration interval recommendation based on at least one of criticality, usage, and age of a Measurement & Test Equipment (M&TE) in the reliability group.

11. The method of claim 1, further comprising performing, at the processor, delay dating of a M&TE in the reliability group based on conditional reliability.

12. A non-transitory computer-readable medium storing instructions that, when executed by one or more processors, cause the one or more processors to:
determine, based on historical data associated with a reliability group, a model fit metric for each reliability model of a plurality of reliability models;
select a particular reliability model based on the model fit metrics;
estimate calibration interval parameters for the reliability group based on the particular reliability model; and
generate a calibration interval recommendation for the reliability group based on the calibration interval parameters and a reliability target associated with the reliability group, wherein the generation of the calibration interval recommendation comprises a selection of a recommended interval from a set of candidate intervals, wherein the recommended interval achieves a reliability value satisfying the reliability target.

13. The non-transitory computer-readable medium of claim 12, wherein the one or more processors are configured to generate initial parameter estimates for each reliability model of the plurality of reliability models.

14. The non-transitory computer-readable medium of claim 12, wherein the model fit metric is a Corrected Akaike Information Criterion (AICc) value.

15. The non-transitory computer-readable medium of claim 12, wherein the estimation of the calibration interval parameters comprises performing a maximum likelihood estimation.

16. The non-transitory computer-readable medium of claim 12, wherein the one or more processors are configured to determine confidence bounds on the calibration interval parameters.

17. The non-transitory computer-readable medium of claim 16, wherein the one or more processors are configured to:
determine a variance and covariance of the calibration interval parameters from an inverse Hessian matrix of a log-likelihood function; and
apply the variance and covariance to establish upper and lower bounds on the calibration interval parameters at a specified confidence level.

18. The non-transitory computer-readable medium of claim 14, wherein the calibration interval parameters include recommended intervals for each of a plurality of reliability values.

19. The non-transitory computer-readable medium of claim 12, wherein the plurality of reliability models comprise at least one of an exponential model, a Weibull model, a lognormal model, and a mortality drift model.

20. A device comprising:
one or more processors coupled to a memory configured to:
determine, based on historical data associated with a reliability group, a model fit metric for each reliability model of a plurality of reliability models;
select a particular reliability model based on the model fit metrics;
estimate calibration interval parameters for the reliability group based on the particular reliability model; and
generate a calibration interval recommendation for the reliability group based on the calibration interval parameters and a reliability target associated with the reliability group, wherein the generation of the calibration interval recommendation comprises a selection of a recommended interval from a set of candidate intervals, wherein the recommended interval achieves a reliability value satisfying the reliability target.
